(19) United States
(12) Patent Application Publication
(10) Pub. No.: US 2020/0404954 A1
(43) Pub. Date: Dec. 31, 2020

(54) Seed-based Food Product and Methods of Preparation Thereof

(71) Applicant: Phillip W Snyder, Durango, CO (US)

(72) Inventor: Phillip W Snyder, Durango, CO (US)

(21) Appl. No.: 16/914,825

(22) Filed: Jun. 29, 2020

Related U.S. Application Data
(60) Provisional application No. 62/868,315, filed on Jun. 28, 2019.

(51) Int. Cl. A23L 27/14; A23L 3/3463; C12J 1/00

(52) U.S. Cl. CPC A23L 27/14; C12J 1/00; A23L 3/3463

(57) ABSTRACT

A novel seed-based spread and food product that is minimally processed comprising three principal ingredients, namely ground seeds (seed butter), vinegar and honey, in addition to a small amount of salt is described.

### RELATED APPLICATIONS

This application claims priority to and incorporates fully by reference herein U.S. Provisional application No. 62,868,315 entitled Seed-based spreads and methods of preparation filed on Jun. 28, 2019.

### BACKGROUND

Food products, and in particular spreads, dips and dressings comprised significantly of ground seeds are very common in the marketplace with peanut butter being particularly popular but sesame seed spread and dips, such as tahini, being popular as well. In recent years, the desire for minimally processed natural foods has increased considerably with the recognition that the application of high heat to certain foods, such as roasting seeds, can deleteriously alter the food's composition and nutritional value. Furthermore, adding chemicals to the food to help extend shelf life and presentability can also have a negative effect on the product's nutritional value not to mention prohibit the product from being marketed as “natural” or “organic”. For example, after sitting for a relatively short period, the oils in minimally processed tahini or peanut butter separate from associated seed solids and cause pooling.

The short shelf life of natural spreads inhibits their widespread distribution in grocery stores and the like, whom would prefer to stock items that do not require refrigeration, or inordinate attention after stocking to ensure compliance with sell by date requirements. Additionally, the separation of the components and pooling of natural oils as is common with natural minimally processed products causes the appearance of the product to be less desirable to a significant percentage of the consuming public. The consuming public has become accustomed to similar and less expensive processed products that do not exhibit oiling off and will often choose these processed products regardless of health benefits offered by natural and organic counterparts.

### DETAILED DESCRIPTION

Embodiments of the present invention comprise novel seed-based spreads (also referred to herein as base mixtures) that are minimally processed and offer significantly improved shelf stability over other similar natural and/or organic products of the same general type. Broadly, the embodiments are comprised of three principal ingredients, namely ground seeds, vinegar and honey, in addition to a small amount of salt that are combined in a specific manner to create the base mixture. Depending on the specific food product being produced, such as a spread or a derivative dip or dressing, and a desired flavor profile, supplemental ingredients can be added to create a final food product.

Typically, embodiments of the base mixture and the food products produced therefrom are characterized by both a low PH and a low water reactivity. The presence of these characteristics greatly inhibit the growth of bacteria and slow spoilage resulting in a more shelf stable natural or minimally processed food product.

In at least one embodiment of the base mixture and its variations, the seeds used in the base mixture are one or more of sesame, sunflower and pumpkin seeds. These seeds can be raw, unroasted, untoasted, and/or processed with high heat in any fashion either before or after grinding into a powder or paste. The vinegar used in this embodiment typically comprises an undiluted and undistilled apple cider vinegar, which typically has an acetic acid content of about 8%. This acid content is generally higher than the acid content of other types of vinegar. The honey used can vary, although unprocessed honey is generally, but not necessarily, preferred. Salt is also typically specified but can be omitted in some variations. The typical base mixture comprises the following proportions of the foregoing ingredients: about 40% ground seeds; about 24% vinegar; about 35% honey; and about 1% salt. At least one variation of the base mixture has a water activity of 0.85 or less and/or a pH of 4.2 or less.

The embodiment of the base mixture briefly described above typically has the consistency of a spread, such as a nut butter, is healthful and flavorful, and can be consumed in this form without further modification. The low water reactivity and low pH also make it reasonably shelf stable especially when compared to other natural products. However, the base mixture can be modified significantly and substantially to create other embodiments of food products for different uses, such as a dressing or a dip, and with different flavor profiles. It is further understood that by modifying the relative proportions of the three primary ingredients in the base mixture, its viscosity can be varied somewhat tailoring it to a specific use. For instance, using a higher percentage of vinegar and a slightly lower percentage of ground seeds may result in a product that is more fluid and therefore more suitable as a dressing. Additionally, other oils and water can be added to the base mixture to lower the viscosity of the resulting desired food product.

Supplemental ingredients such as fruit and vegetable powers and herbs and spices can be added to embodiments of the base mixture to create food products having desired flavor profiles. As an additional benefit at least some fruit powders are acidic and can further act to lower the pH and the water reactivity of a resulting food product in which they are utilized. Possible fruit powders that can be added to the base mixture include cranberry, raspberry and mango although powders of other fruits can be used as well. Further, about any vegetable powder that provides desirable flavor characteristics can be used. The types of powdered herbs and spices that can be added to the base mixture are also exhaustive and by way of example can include mustard, turmeric, garlic, jalapeno.

In addition to being relatively shelf stable, embodiments of the base mixture, if combined in a manner described herein, naturally emulsify and resist oiling off as is typical of many natural and/or minimally processed spreads and dips. As an initial step in one method of creating an embodiment of the base mixture the desired seeds are prepared by fine grinding. The process is controlled to minimize the creation of excess heat within the seeds and resulting seed butter to minimize the deleterious effect heat has on the nutritional value of the seeds. Ideally, the seeds and seed butter are kept at a temperature of 46 degrees Celsius or less. To maximize the ability of the seed butter to bind with the other components and naturally emulsify, a very fine grind is most desirable.

The finely ground seed butter is then combined with pure apple cider vinegar. Typically, the finely ground seed butter, which has a thick liquid consistency is poured into the mixing vat or bowl containing the vinegar or visa versa. Wherein herbs, spices or other flavorings are to be used to flavor the mixture, they can be added to the vinegar and steeped therein prior to the addition of the seed butter. The temperature of the vinegar prior to the addition of the seed butter can be slightly elevated to about 46 degrees Celsius and maintained at this temperature to promote the chemical interaction between the two primary components creating a paste like consistency.

The honey, which is typically warmed to about 46 degrees Celsius, is added to the paste-like seed and vinegar mixture only after the seed and vinegar mixture has been fully mixed. The honey is then blended into the paste, which results in a smooth consistency more akin to peanut butter or hummus than a crumbly paste.

Finally, salt can be added to the mixture and mixed therein to complete the base mixture. There after the product can be packaged for distribution and sale, or additional ingredients can be added to change the viscosity of the food product and/or create a desired flavor profile.

The embodiments of the seed-based food products typically offer one or more of a multitude of benefits and advantages. The ingredients of the products and, in particular, the seed butter, remain essentially raw because of minimal processing and the use of relatively low heat. Accordingly, the product retains the natural nutritive values of the ingredients. The products also have low water activity and a relatively high acidic content which results in products with good shelf life compared to other similar natural products. The ingredients and the specific manner in which they are combined results in products that retain emulsification and resist oiling off and/or oil separation. The products further resist separation of their water content such as onto pieces of bread or crackers on which the products have been spread. The method of combining the ingredients of the products utilize low heat and can be done quickly, minutes instead of hours, resulting in lower energy consumption in production and limits the time that the products can become contaminated before being containerized.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

The abbreviation “pH” as used herein has the meaning as commonly understood in the scientific community. Namely, it refers to a scale used to specify the acidity or alkaline nature of a solution.

The term “salt” as used herein refers to sodium chloride.

The term “raw” as used herein with reference to various ingredients of some of the embodiments refers to a product that has been neither treated with high heat or filtered.

The phrase “water activity” as applied to a food refers to a ratio between the vapor pressure of the food itself, when in a completely undisturbed balance with the surrounding air media, and the vapor pressure of distilled water under identical conditions. If the amount of available moisture in a food is reduced sufficiently, the growth of organisms will be inhibited. If the water activity of food is controlled to 0.85 or less in the finished product, it is not subject to the regulations of 21 CFR Parts 108, 113, and 114.

### The Ingredients in Embodiments of a Seed-Based Spread and Food Product

Embodiments of the seed-based food product as described above comprise ground seeds (or seed butter), vinegar, and honey. Additionally, a small amount of salt typically comprises a fourth ingredient. The resulting food product referred to herein as the base mixture can be used as a flavorful spread as is, or fruit powders, vegetable powders, herbs and spices can be added to the mixture to create different flavor profiles. Additionally, water and/or oil can be added to the base mixture to create less viscous food products such as, but not limited to, dips and dressings.

Seeds, such as sesame, sunflower and pumpkin play an important and growing role in human nutrition, are cultivated worldwide not only for the extraction of their valuable oils but also for consumption in their more natural state. These three seeds are both interchangeable or combinable in the manner in which they are used in embodiments described herein.

The sesame plant, Sesamum indicum, has been raised as a food crop for several millennia, probably originating in ancient India or the region of the Tigris and Euphrates Rivers in Iraq. In many cultures, the seeds of this flowering plant are processed into tahini, a paste made from ground hulled sesame seeds. Tahinis in their basic forms, as well as the whole seeds, have been widely used in the Orient, India, the Middle East, Africa, and Mediterranean countries as a side dish, garnish, or base for other products such as hummus. The types of dishes are as varied as the number of countries or regions in which it is consumed. Its wide popularity is evidenced by the number of manufacturers, well over 100, both American and foreign, that make a form of tahini for sale in this country.

Most tahini is made with white or hulled sesame seeds which, like peanuts, have been lightly roasted to bring out that a nutty flavor. At least some embodiment base mixtures are produced following a more organic or natural approach using only untoasted seeds, given that any high heat processes diminish the nutritional value of most foods, altering their chemical composition and degrading their valuable enzyme content. Sesame seeds are a desirable food since they contain not only all nine of the essential amino acids but ten others as well. Research has shown that raw sesame butter contains 4.4% more protein and higher amounts of minerals than tahini made with roasted seeds. Additionally, heat begins to break down antioxidant components contained with the oil of sesame seeds.

Sunflowers (genus Heliantrhus) in their earlier genetic forms-arose in the Americas, where several local varieties grew wild. Initially collected by hunter-gatherer tribes, the Cherokee, the Aztecs and other tribes began to cultivate the flower for their seeds. After European colonization, sunflowers, like tomatoes, potatoes and other native foods, were transported back to Spain, thence throughout Europe. The greatest proponent of sunflower cultivation turned out to be Peter the Great, who took the species to Russia, where it was farmed for its oil and eventually developed into the giant sunflower species, Helianthus giganteus. The common sunflower, Helianthus annuus, has remained the most predominant edible sunflower seed source in the United States today.

While there are three types of sunflower seeds in common use, those with striped hulls are primarily used for food. They are generally referred to as confectionery sunflower seeds, as opposed to those varieties with black-hulled seeds which are grown for oil production. The raw sunflower kernels have a slightly more nutty and sweeter taste compared to sesame kernels. Seeds in the shell are particularly popular in Mediterranean, Eastern European, and Asian countries where they can be bought freshly roasted and are commonly purchased as street food, the hull being cracked open with the teeth and spit out. In many countries, they can be bought freshly packed in various roasted flavors. In the United States, they are well-known as an in-game snack of baseball players, but they are often used as garnishes or included as components of various recipes. The seeds can also be sprouted and are frequently added to salads in that form. The kernels may be sold raw or roasted and are sometimes added to bread or other baked goods to enhance flavor. Several manufacturers also produce sunflower butter, using either the plain kernels, raw or roasted, or sprouted seeds, which also contain all nine of the essential amino acids. For the same reasons provided for sesame seeds, at least some of the embodiments utilize raw sunflower seeds.

A pumpkin seed is the edible seed of a favorite Halloween harvest product, one of the squash family known as Cucurbita pepo. The earliest known evidence of the domestication of pumpkins was probably undertaken in Mesoamerica 8,000-10,000 years ago, predating that of crops such as maize and beans some 4,000 years later. Pumpkin seeds were once used as an anthelmintic in traditional medicine by indigenous people of the Americas to expel tapeworms and other intestinal parasites. The seeds were first listed in the United States Pharmacopoeia as an antiparasitic in 1863. The popularity of pumpkin seeds has spread over centuries from the Americas to the rest of the globe through trade and exploration. In parts of Eastern Europe and the Mediterranean, notably in Greece, pumpkin seeds have become a principal part of everyday cuisine. Pumpkin seeds also hold a place of importance in the culinary and medicinal traditions in India and other parts of Asia also incorporated the seeds into a place of importance. China currently produces more pumpkin seeds than any other country, but India, Russia, Ukraine, Mexico, and the United States are also major producers.

Pumpkin seeds are typically rather flat and asymmetrically oval and light green in color and may have a white outer hull. Some varieties are hulless and are grown only for their seed. The seeds are more comparable to sunflower kernels in taste and sweetness than to sesame seeds. Like the other seeds, they are nutrient-rich, especially in zinc, and high in protein, containing all of the essential amino acids. In many uses, they are lightly roasted or toasted like other seeds, but at least some of the embodiments described herein only use untoasted seeds.

Embodiments of the invention can use any suitable type of vinegar although in at least some embodiments apple cider vinegar (also referred to as ACV herein) is preferred because of, at least in part, its higher acid content. ACV is an aqueous solution of water, acetic acid and small amounts of other ingredients that are part of the apple juice, which has fermented first from juice to cider and then to vinegar. Today, ACV is used primarily in salad dressings, pickling, sauces and other manners of cooking. Its history traces back at least 5,000 years to Babylonian civilization when it was used as a preservative and a condiment as it still is today. More recently ACV has been touted as having significant healthful attributes. The unfiltered, unpasteurized vinegar used in some embodiments of the present invention is typically produced through a slow fermentation process which can take from a few months to a year. Its recent popularity is evidenced by the growth of the apple cider vinegar market, which is projected to increase at an annual rate of 5.7% from 2018 through 2026.

While the embodiments specifically described herein use of apple cider vinegar, other embodiments of the base mixture can be produced using most commercially available vinegars, including, but not limited to, red wine vinegar, white wine vinegar, balsamic vinegar, rice vinegar, coconut milk vinegar and numerous artisanal fruit vinegars. However, it is appreciated that the acetic acid in apple cider vinegar may be more effective than fruit acids of other vinegars in the generation of a high viscosity product that is more shelf stable than one made with vinegars, which have other fruit acids as a principal component. Further, based on the subjective pallet of consumers, ACV may contribute to a more desirable base mixture in terms of taste, texture and homogeneity.

During fermentation apple cider vinegars, and other types of vinegars, typically lose much of any antioxidant phenolic compounds present in the fruit from which it is made. Accordingly, in some embodiments, selected high antioxidant spices, herbs or other flavorings, which do not inhibit the physical interactions discussed below, may be steeped in the vinegar creating an enhanced vinegar prior to the vinegar's addition to the seed butter. It is believed that the polyphenols released from the herbs and spices bind with certain amino acids in the seed proteins during mixing. The added antioxidants are also believed to inhibit subsequent oxidation, especially that of lipids within the mixture.

Honey has been consumed by humans since before recorded history. Today, most honey for human consumption is produced in domesticated bee colonies. The physical properties of honey vary, depending on its water content, the type of flora selected by the bees, temperature, and the proportion of the specific sugars it contains. All varieties are suitable for use in embodiments of the base mixture and the methods of making the base mixture. While honey is primarily comprised of fructose and glucose with small amounts of other sugars, it also contains minerals, proteins and other components from the flower nectar and pollens. The presence of gluconic acid from the bees' digestive process makes honey acidic with a pH that can range from 3.40 to 6.10. Honey is also supersaturated liquid, containing more sugar than the water can typically dissolve at ambient temperatures. While its hydrophilic nature can cause it to absorb water from the atmosphere, it can also bind with water in food products, making it a recognized humectant in the industry. Since few microorganisms grow in honey, properly sealed honey will not spoil, even after thousands of years.

Several embodiments of the base mixture utilize raw honey, which has not been filtered or heated. Some other embodiments may use honey that has been filtered but not pasteurized. Other embodiments may use regular honey which is typically both filtered and pasteurized.

As mentioned above additional ingredients in the form of fruit and vegetable powders, spices, and herbs may be added to the base mixture at any stage of its production. For instance, the vinegar used in the base mixture can be steeped with various herbs and spices prior to being mixed with a seed butter. However, in some embodiments, any supplemental ingredients added to change the flavor profile of the base mixture are added as a last step in the production process.

Over the past several years, with the development and refinement of technologies and equipment, food processors have been able to spray dry or freeze dry in powdered form numerous fresh fruits and vegetables, both common and exotic. Although the initial three ingredients with or without added salt form a base mixture that typically has a pH of around 4.2 and a water activity reading typically less than 0.85, embodiments can also include typically small amounts of acidic fruit juice powders. Fruit flavors, such as cranberry, raspberry, and mango can be added to the base mixture and act not only to provide a desired flavor profile but also act to further lower the water activity below 0.85. More acidic fruits like cranberry will further lower the pH. Use of these ingredients also follows with the trending demand for simple, minimally processed products comprised of only natural ingredients.

Finally, the use of powdered herbs and spices further allows the creation of a wide variety of finished products. For example, mustard and turmeric powders can be added to the base mixture to create a honey-mustard spread. Garlic powder can be added to the base mixture to create a roasted garlic spread. Red jalapeno and garlic powders can be added to the base mixture to create a sriracha flavor, and curry spice can be added to the base mixture to create an East Indian-flavored spread.

Embodiments of the base mixture described herein are produced using minimal processing other than mixing with the temperatures used during the process being largely limited to approximately 46 degrees Celsius. These same embodiments may utilize only raw ingredients that have not been processed prior to use. Nevertheless, the various process embodiments used to produce the base mixtures result in a mixture that resist oiling off and resist water content bleeding off of the mixture onto and into a piece of bread or a cracker in which a spread made from the base mixture may be applied. Additionally, embodiments of the base mixture exhibit low water activity and a low pH, making the mixture and spreads and other products derived from the mixture shelf stable compared with other seed-based natural products in the marketplace.

### Methods of Producing Embodiments of the Base Mixture

Unroasted seeds are milled into very fine 10-60 μm. Variations in measured viscosity depend on how fine the seeds are ground. Seed butters are produced through a multi-stage grinding process in which the heat generated is controlled and maintained at a temperature typically not exceeding approximately 46° Celsius. Alternatively, the seed butter can be purchased from certified manufacturers or custom ground by them to the foregoing specification. The grinding facilitates the breaking of the cellular structure, releasing more of the seed oils (not generally available in a coarser grind) and other seed components (including the seed proteins) and making them more available for the chemical and physical interactions that take place on the molecular level. The very fine grind can also provide a base mixture with a smoother and more favorable final texture. The raw seed butter may be allowed to cool to room temperature prior to any mixing action but the binding efficiency may be maximized if the seed butter is maintained at an elevated temperature of approximately 46-48 degrees Celsius.

Generally, the measured volume of vinegar is poured into a mixing container, which is often jacketed. The temperature is kept to as close to 46-48 Celsius as is possible to help control protein denaturation. After the addition of the enhanced or unenhanced vinegar to the seed butter, the ingredients are typically mixed at high speed (between 10 to 20 seconds). The temperature of mixture which is typically maintained at approximately 46° Celsius, facilitating easier mixing. The seed proteins, which are believed to have begun denaturing during grinding and as a result of being subjected to a slightly elevated temperature of approximately 46 degrees Celsius, are believed to further denature when mixed with the acetic acids in the vinegar, forming strong, physical interactions between unfolded proteins as well as new electrostatic interactions that bind water and stabilize the mixture.

As understood by the applicant, during the temperature controlled mixing, the lecithin in the seed butter oils may act as an emulsifying agent to also bind these oils to the water in the vinegar that typically makes up more than 90% of the volume of the vinegar. While it is suspected that there is some binding through a typical emulsion process, calculations performed by the applicant based on a mean average of the oleic acid contained in the seeds of the seed butter suggest that only a small percentage of the free water in the apple cider vinegar is emulsified. It is believed that this leaves most of the vinegar's water molecules free for additional means of physical interaction with the denatured proteins.

As understood and believed by the applicant concerning the mixing of the seed butter and the vinegar, proteins in the seed butter is denatured in two ways: first by the introduction of acids from the vinegar, and second by subjecting the butter and the mixture to low heat. The application of heat causes denaturation by increasing molecular motion until stabilizing interactions are broken and the proteins unfold as a result. Acid denaturation causes an alteration of the protein protonation state, and thus net charge, also disrupting stabilizing interactions and permitting the proteins to unfold.

As understood by the applicant as it relates to food science, folded proteins are stabilized by electrostatic interactions between amino acids (enthalpic effect) and by the exclusion of water from the interior hydrophobic portions of the protein molecule (entropic effect). The exclusion of water from the interior of the folded protein is facilitated by electrostatic interactions with water being broken and replaced by electrostatic interactions between amino acids. As proteins denature, electrostatic interactions between amino acids that stabilize the folded state are disrupted, allowing unfolding to begin. As indicated above the denaturing may be accomplished by heat or acid. As the protein unfolds, hydrophobic and hydrophilic regions are exposed to water supplied by the vinegar. The hydrophilic regions form new electrostatic interactions with the water. The hydrophobic regions of unfolded proteins associate with each other as they are unable to interact with water as it is entropically favorable to exclude water in this region. It is believed that the denaturation process both traps water in new electrostatic interactions with the exposed hydrophilic amino acids and forms stable aggregates of unfolded proteins that associate through their hydrophobic regions. As understood, the types and extent of both electrostatic interactions and the hydrophobic packing that occurs as protein aggregates form is dependent on the method and extent of the denaturation. Accordingly, by controlling the denaturation process food products with differing consistency and stability due to the unique aggregated protein matrix can be produced.

It is believed the high-speed mixing encourages stronger physical interactions in reduced time by helping maintain the temperature of the mixture at an optimum level. Typically within a short period of mixing (often measured in 10-20 seconds), the seed and vinegar mixture begins to blanch transforming its consistency into a distinctive, semi-crumbly paste that is noticeably different from the consistencies of primary ingredients separately or prior to mixing.

After high speed mixing (between 10-20 seconds) in some process embodiments, the seed butter/apple cider vinegar mixture is allowed to cool to at least 35 Celsius. It is believed that this helps preserve the enzymes in the raw honey from degradation when added to the mixture. The honey is typically pre-warmed to a temperature of up to 35 degrees Celsius to facilitate ease of pouring. In at least some variations of the process, the honey is poured into the resulting paste seed butter and vinegar mixture and thoroughly blended. The addition of honey not only imparts sweetness to the mixture but is also believed to act as a natural preservative. Specifically, the glucose, fructose and other sugars in the honey may act as humectants, binding more free water not already effected by the other chemical processes. Small amounts of proteins and polyphenols naturally occurring in the honey may also strengthen the binding matrix. Addition of the honey, depending on its pH, may lower the pH of the resulting base mixture over the seed butter and vinegar mixture.

Salt can be added to the mixture either after or with the addition of the honey and also blended in. In some embodiments the salt can be added at different points in the process, or even added at several different points. The salt acts as both a flavoring and as a humectant, further lowering the water activity and increasing the shelf stability of the final product.

In some embodiments, the base mixture comprises a standalone product that can be consumed without the addition of additional flavorings. As an optional final step in the process, any desired natural flavorings, such as powdered fruit juices, spices or herbs, can be added and blended into the base mixture. The final product is then packaged for distribution and sale.

### Composition of the Base Mixture According to Embodiments

As can be appreciated the relative amounts of each of the primary three or four ingredients can vary somewhat depending on factors such as but not limited to the oil content of the seed butter, the acid content of the vinegar, and the water content of the vinegar. It is further appreciated that different types of honey, whether processed or raw, and the water content of the honey can affect its relative percentage in the mixture. In at least some embodiments the base mixture comprises about 40% ground seeds (or seed butter); about 24% vinegar; about 35% honey; and 0-1.2% salt. In more preferred embodiments, the base mixture comprises approximately 40% ground seeds (or seed butter), approximately 40% ground seeds (or seed butter); approximately 24% vinegar; approximately 35% honey; and 0-1.2% salt. The amount of vinegar by weight listed above assumes that any ingredients that have been added to the vinegar, such as by steeping, are considered part of the vinegar. This three to four-ingredient base mixture can be flavored as further described below or additional ingredients, such as oil and water, added to change the character of the base mixture from that of a spread to a dip which is less viscous or a dressing which is even less viscous still. As indicated above in some embodiments, the base mixture can comprise a standalone product that can be consumed without the addition of additional flavorings. The total amount of flavoring ingredients added typically vary from about 2-8% depending up the strength of each ingredient, although this can vary as well. For example, a honey-mustard spread may contain 5.5% yellow mustard powder and 0.7% turmeric powder with the remaining 93.8% comprising the base mixture in the relative proportions indicated above.

As mentioned above, the base mixture with or without added flavorings typically has the consistency of a spread that can be used on bread or crackers. The product resists oiling out during storage and water bleed in use on a carrier, such as bread. With minimal modification through the addition of water or oil either prior to packaging or at time of use, the base mixture can be transformed into a dip, sauce or dressing to be used with chips, vegetables, fish and meats, or on a salad. Numerous other uses are contemplated as well as would be obvious to one of ordinary skill given the benefit of this disclosure.

The base mixture and finished products made from the base mixture will typically have a pH of around 4.2 or lower and a water activity reading of 0.85 or below. With these characteristics the base mixture and associated food products exhibit a high degree of shelf stability when compared to other raw or minimally processed food products that do not contain or utilize added preservative or chemicals.

### Alternative Embodiments and Other Variations

The various embodiments and variations thereof described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

For instance, variations are contemplated that use other types of seeds and nuts, and other types of vinegar. While the embodiments described herein generally pertain to a natural-type spread that uses raw or minimally processed ingredients, it is appreciated that embodiments and variations are also contemplated that use one or more processed ingredients, such as roasted sesame seeds in a variation designed to provide a roasted sesame flavor. Further, while the embodiments described above largely do not require nor make use of supplemental preservatives or additives, variations are contemplated that might. Additionally, all sorts of derivative products are contemplated wherein the base mixture is combined with other ingredients to make a significantly different food product. In the end, the potential uses for the base mixture described and herein are virtually endless.

I claim:

1. A food product, a blended mixture of the following by weight:
about 40% seed butter;
about 24% vinegar; and
about 35% honey;
wherein the mixture has a pH of no more than about 4.2, and a water activity of no more than 0.85.

2. The food product of claim 1, further comprising 0.1-1.2% salt.

3. The food product of claim 1 in combination with one or more flavorings from the group of fruit powder, vegetable powder, spices, and herbs, wherein the flavorings are mixed into the food product with the food product comprising about 90-98% by weight and the flavorings comprising about 2-10% by weight.

4. The food product of claim 2 in combination with one or more flavorings from the group of fruit powder, vegetable powder, spices, and herbs wherein the flavorings are mixed into the food product with the food product comprising about 90-98% by weight and the flavorings comprising about 2-10% by weight

5. The food product of claim 2, wherein the food product resists oiling off.

6. The food product of claim 2, wherein the seed butter substantially consists of one or more of sesame seeds, ground sunflower seeds, and ground pumpkin seeds.

7. The food product of claim 6, wherein the one or more of sesame seeds, sunflower seeds, and pumpkin seeds are raw.

8. The food product of claim 6, wherein the vinegar comprises apple cider vinegar.

9. The food product of claim 7, wherein the vinegar comprises apple cider vinegar, and the apple cider vinegar is raw.

10. The food product of claim 9, wherein the honey is raw.

11. A method of producing the food product of claim 6 comprising:
providing the seed butter;
mixing the seed butter with vinegar at a temperature of about 46 degrees Celsius until a seed and vinegar mixture with a paste-like consistency is achieved;
permitting the seed and vinegar mixture to cool to at least 35 degrees Celsius;
mixing honey into the seed and vinegar mixture until a smooth consistency is achieved; and
mixing salt into the seed and vinegar mixture.

12. The method of claim 11, wherein the one or more seeds in the seed butter are ground to a fineness of 10-60 μm.

13. The method of claim 11, wherein the seed butter, the vinegar and the honey are raw.

14. The method of claim 11, wherein the vinegar comprises raw apple cider vinegar.

15. The method of claim 11 further comprising: grinding the one or more seeds to a fineness of 10-60 μm to create the seed butter while maintaining the temperature of the one or more seeds and seed butter to about 46 degrees Celsius.

16. The method of claim 11 further comprising: warming the honey to up to 35 degrees Celsius before said mixing honey into the seed and vinegar mixture.

17. The method of claim 11, further comprising mixing one or more flavorings into the food product, the flavoring being selected from the group of: fruit powder, vegetable powder, herbs, and spices.

18. The method of claim 11, wherein said mixing the seed butter with vinegar comprises high speed mixing for between 10 and 20 seconds.

19. A method of producing the food product of claim 10 comprising:
grinding the one or more of sesame seeds, sunflower seeds, and pumpkin seeds to a fineness of 10-60 μm to create the seed butter while maintaining the temperature of the one or more sesame seeds, sunflower seeds, and pumpkin seeds and seed butter to about 46 degrees Celsius during mixing;
high speed mixing the seed butter with apple cider vinegar at a temperature of about 46 degrees Celsius until a seed and vinegar mixture with a paste-like consistency is achieved;
permitting the seed and vinegar mixture to cool to at least 35 degrees Celsius;
warming the honey to up to 35 degrees Celsius before said mixing honey into the seed and vinegar mixture;
mixing honey into the seed and vinegar mixture until a smooth consistency is achieved; and
mixing salt into the seed and vinegar mixture.

20. The method of claim 19, further comprising mixing one or more flavorings into the food product, the flavoring being selected from the group of: fruit powder, vegetable powder, herbs, and spices.
